(19) United States
(12) Patent Application Publication
(10) Pub. No.: US 2021/0293681 A1
(43) Pub. Date: Sep. 23, 2021

(54) INFORMATION PROCESSING APPARATUS, CONTROL METHOD, AND NON-TRANSITORY STORAGE MEDIUM

(71) Applicant: NEC Corporation, Minato-ku, Tokyo (JP)

(72) Inventors: Ryota SUZUKI, Tokyo (JP); Riki ETO, Tokyo (JP)

(73) Assignee: NEC Corporation, Minato-ku, Tokyo (JP)

(21) Appl. No.: 17/262,022

(22) PCT Filed: Jul. 31, 2018
(86) PCT No.: PCT/JP2018/028564

§ 371 Date: Jan. 21, 2021

(51) Int. Cl. G01N 5/02

(52) U.S. Cl. CPC G01N 5/02

(57) ABSTRACT

An information processing apparatus (2000) acquires time-series data (14) output by a sensor (10) and computes a contribution value ξᵢ representing contribution with respect to the time-series data (14) for each of a plurality of feature constants θᵢ. Thereafter, the information processing apparatus (2000) outputs a set Ξ of the contribution values ξᵢ as a feature value of a target gas. As the feature constant θ, a velocity constant β or a time constant τ that is a reciprocal of the velocity constant can be adopted.

### TECHNICAL FIELD

The present invention relates to an analysis of a feature of gas.

### BACKGROUND ART

A technique has been developed to obtain information related to gas by measuring the gas with a sensor. Patent Document 1 discloses a technique for discriminating the type of sample gas by using a signal (time-series data of detected values) obtained by measuring the sample gas with a nanomechanical sensor. Specifically, since a diffusion time constant of the sample gas with respect to a receptor of the sensor is determined by a combination of the type of the receptor and the type of the sample gas, it is disclosed that the type of the sample gas can be discriminated based on the diffusion time constant obtained from the signal and the type of the receptor.

### RELATED DOCUMENT

### Patent Document

[Patent Document 1] Japanese Patent Application Publication No. 2017-156254

### SUMMARY OF THE INVENTION

### Technical Problem

In Patent Document 1, it is assumed that one type of molecule is contained in the sample gas, and it is not assumed that the sample gas in which a plurality of types of molecules are mixed is handled. The present invention has been made in view of the above problems and is to provide a technique for extracting a feature of gas in which a plurality of types of molecules are mixed.

### Solution to Problem

An information processing apparatus of the present invention includes: 1) an acquisition unit that acquires time-series data of detected values output from a sensor where a detected value thereof changes according to attachment and detachment of a molecule contained in a target gas;

a computation unit that computes a contribution value representing a magnitude of contribution for each of a plurality of feature constants with respect to the time-series data; and 2) an output unit that outputs the contribution value computed for each feature constant as a feature value of gas sensed by the sensor, in which the feature constant is a time constant or a velocity constant related to a magnitude of a temporal change of the number of molecules attached to the sensor.

A control method of the present invention is a control method executed by a computer. The control method includes: 1) an acquisition step of acquiring time-series data of detected values output from a sensor where a detected value thereof changes according to attachment and detachment of a molecule contained in a target gas; 2) a computation step of computing a contribution value representing a magnitude of contribution for each of a plurality of feature constants with respect to the time-series data; and 3) an output step of outputting the contribution value computed for each feature constant as a feature value of gas sensed by the sensor, in which the feature constant is a time constant or a velocity constant related to a magnitude of a temporal change of the number of molecules attached to the sensor.

A program of the present invention causes a computer to execute each step included in the control method of the present invention.

### Advantageous Effects of Invention

According to the present invention, there is provided a technique for extracting a feature of gas in which a plurality of types of molecules are mixed.

### BRIEF DESCRIPTION OF THE DRAWINGS

The above-described object, other objects, features, and advantages will be further clarified by the preferred embodiments described below and the accompanying drawings.

FIG. 1 is a diagram illustrating an outline of an information processing apparatus according to Example Embodiment 1.

FIG. 2 is a diagram illustrating a sensor for obtaining data acquired by the information processing apparatus.

FIG. 3 is a diagram illustrating a functional configuration of the information processing apparatus according to Example Embodiment 1.

FIG. 4 is a diagram illustrating a computer for implementing the information processing apparatus.

FIG. 5 is a flowchart illustrating a flow of a process executed by the information processing apparatus of Example Embodiment 1.

FIG. 6 is a diagram illustrating a plurality of time-series data obtained from the sensor.

FIG. 7 is a diagram illustrating a feature value obtained for a single molecule.

FIG. 8 is a diagram illustrating a feature vector Ξ in a graph.

FIG. 9 is a diagram illustrating a case where the feature vector is obtained from each of rising time-series data and falling time-series data.

FIG. 10 is a diagram illustrating a case where a plurality of feature vectors are obtained by obtaining the time-series data from each of a plurality of sensors.

FIG. 11 is a block diagram illustrating a functional configuration of the information processing apparatus according to Example Embodiment 2.

FIG. 12 is a flowchart illustrating a flow of a process executed by the information processing apparatus of Example Embodiment 2.

### DESCRIPTION OF EMBODIMENTS

Hereinafter, embodiments of the present invention will be described with reference to the drawings. In all the drawings, the same constituents will be referred to with the same numerals, and the description thereof will not be repeated. Further, in each block diagram, each block represents a functional unit configuration, not a hardware unit configuration, unless otherwise specified.

### Example Embodiment 1

<Outline of Invention and Theoretical Background>

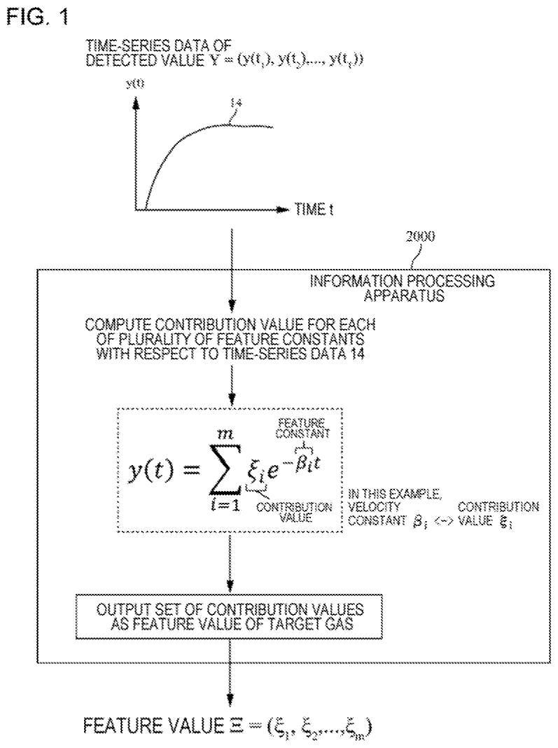

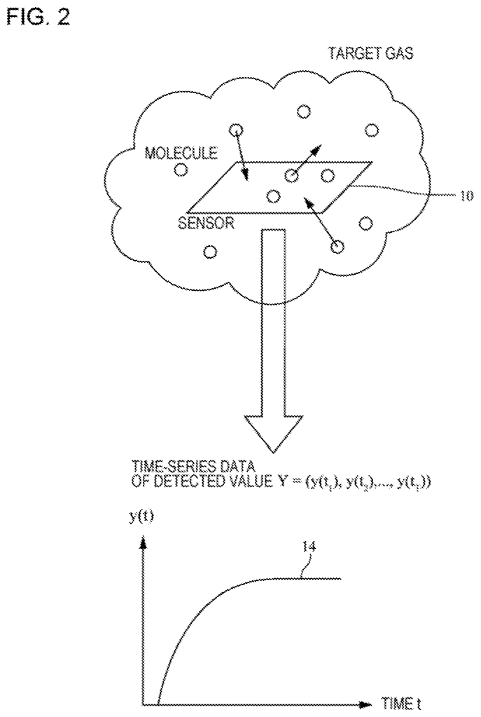

FIG. 1 is a diagram illustrating an outline of the information processing apparatus 2000 of Example Embodiment 1. Further, FIG. 2 is a diagram illustrating a sensor 10 for obtaining data acquired by the information processing apparatus 2000. The sensor 10 is a sensor that has a receptor to which a molecule is attached and whose detected value is changed according to attachment and detachment of the molecule at the receptor. Note that, the gas sensed by the sensor 10 is called a target gas. Further, time-series data of detected values output from the sensor 10 is called time-series data 14. When necessary, the time-series data 14 is also expressed as Y, and the detected value at time t is also expressed as y(t). Y is a vector in which y(t) is enumerated.

For example, the sensor 10 is a Membrane-type Surface Stress (MSS) sensor. The MSS sensor has a functional membrane to which a molecule is attached as a receptor, and stress generated in a supporting member of the functional membrane is changed due to the attachment and detachment of the molecule with respect to the functional membrane. The MSS sensor outputs the detected value based on the change in the stress. Note that, the sensor 10 is not limited to the MSS sensor, may output the detected value based on changes in physical quantities related to the viscoelasticity and dynamic characteristics (the mass, the moment of inertia, or the like) of a member of the sensor 10 that occur in response to the attachment and detachment of the molecule with respect to the receptor, and can adopt various types of sensors such as a cantilever type, a membrane type, an optical type, a Piezo, and an oscillation response.

For the sake of explanation, sensing by the sensor 10 is modeled as follows.

(1) The sensor 10 is exposed to the target gas containing K types of molecules.

(2) The concentration of each molecule k in the target gas is a constant pk.

(3) A total of N molecules can be adsorbed on the sensor 10.

(4) At time t, the number of molecules k attached to the sensor 10 is nₖ(t).

The temporal change of the number of molecules k nₖ(t) attached to the sensor 10 can be formulated as follows.

$$\frac{d {n}_{k} ( t )}{d t} = {α}_{k} {ρ}_{k} - {β}_{k} {n}_{k} ( t ) \qquad ( 1 )$$

The first and second terms on the right side in Expression (1) represent the amount of increase (the number of molecules k newly attached to the sensor 10) and the amount of decrease (the number of molecules k detached from sensor 10) of the molecules k per unit time, respectively. Further, αₖ is a velocity constant representing a velocity at which the molecule k is attached to the sensor 10, and βₖ is a velocity constant representing a velocity at which the molecule k is detached the sensor 10.

Since the concentration ρₖ is constant, the number of molecules k nₖ(t) at time t can be formulated from the above Expression (1) as follows.

$${n}_{k} ( t ) = {n}_{k}^{*} + ( {n}_{k} ( {t}_{0} ) - {n}_{k}^{*} ) {e}^{- {β}_{k} t} wherein \\ {n}_{k}^{*} := \frac{{β}_{k} {ρ}_{k}}{{α}_{k}} \qquad ( 2 )$$

Further, assuming that no molecule is attached to the sensor 10 at time to (initial state), nₖ(t) is represented as follows.

nₖ(t)=nₖ*(1−e^{-β}^{ₖ}^{t}) (3)

The detected value of the sensor 10 is determined by the stress acting on the sensor 10 by the molecules contained in the target gas. It is considered that the stress acting on the sensor 10 by a plurality of molecules can be represented by the linear sum of the stress acting on individual molecules. However, the stress generated by the molecule is considered to differ depending on the type of molecule. That is, it can be said that the contribution of the molecule with respect to the detected value of the sensor 10 differs depending on the type of the molecule.

Thereby, the detected value y(t) of the sensor 10 can be formulated as follows.

$$\begin{matrix}y ( t ) = {\sum }_{k = 1}^{K} {γ}_{k} {n}_{k} ( t ) \\ = \{ \begin{matrix}{ξ}_{0} - {\sum }_{k = 1}^{K} {ξ}_{k} {e}^{- {β}_{k} t} & when rising \\ {\sum }_{k = 1}^{K} {ξ}_{k} {e}^{- {β}_{k} t} & when falling\end{matrix} \end{matrix} \\ wherein {ξ}_{k} = \frac{{γ}_{k} {α}_{k} {ρ}_{k}}{{β}_{k}} ( k = 1 , … , K ) , {ξ}_{0} = {\sum }_{k = 1}^{K} {ξ}_{k} \qquad ( 4 )$$

Both γₖ and ξₖ represent the contribution of the molecule k with respect to the detected value of the sensor 10. Note that, the meanings of “rising” and “falling” will be described later.

When the time-series data 14 obtained from the sensor 10 that senses the target gas can be decomposed as in the above Expression (4), it is possible to recognize the types of molecules contained in the target gas and the ratio of each type of molecules contained in the target gas. That is, by the decomposition represented by Expression (4), data representing the feature of the target gas (that is, the feature value of the target gas) can be obtained.

The information processing apparatus 2000 acquires the time-series data 14 output by the sensor 10, and decomposes the time-series data 14 as shown in the following Expression (5) by using a set of feature constants Θ={θ₁, θ₂, . . . , θₘ}. Note that, as will be described later, the set Θ of the feature constants may be predetermined or may be generated by the information processing apparatus 2000.

$$y ( t ) = {\sum }_{i = 1}^{m} {ξ }_{i} f ( {σ}_{i} ) \qquad ( 5 )$$

ξᵢ is a contribution value representing the contribution of the feature constant θᵢ with respect to the detected value of the sensor 10.

By such decomposition, the information processing apparatus 2000 computes the contribution value ξᵢ that represents the contribution of each feature constant θᵢ with respect to the time-series data 14. Thereafter, the information processing apparatus 2000 outputs a set Ξ of the contribution values ξᵢ as a feature value that represents the feature of the target gas. The set of the contribution values ξᵢ is represented by, for example, the feature vector Ξ=(ξ₁, ξ₂, . . . , ξₘ) that enumerates ξᵢ. In the following description, unless otherwise specified, the feature value Ξ is represented by a vector. However, the feature value of the target gas does not necessarily have to be represented as a vector.

As the feature constant θ, the above-mentioned velocity constant β or the time constant τ, which is the reciprocal of the velocity constant, can be adopted. Expression (5) can be represented as follows for each of the cases where β and τ are used as θ.

$$\begin{matrix}y ( t ) = {\sum }_{i = 1}^{m} {ξ}_{i} {e}^{- {β}_{i} t} & ( 6 ) \\ y ( t ) = {\sum }_{i = 1}^{m} {ξ}_{i} {e}^{- t / {τ}_{i}} & ( 7 )\end{matrix}$$

<Action and Effect>

As described above, since the contribution of the molecule with respect to the detected value of the sensor 10 is considered to differ depending on the type of the molecule, the set Ξ of the above-mentioned contribution values is considered to be different depending on the type of the molecule contained in the target gas and a mixing ratio thereof. Therefore, the set Ξ of contribution values can be used as information with that gases in which a plurality of types of molecules are mixed can be distinguished, from each other, that is, as the feature value of the gas.

Therefore, the information processing apparatus 2000 of the present example embodiment computes the set Ξ of the contribution values that represents the contribution of each of the plurality of feature constants with respect to the time-series data 14 based on the time-series data 14 obtained by sensing the target gas with the sensor 10 and outputs the computed set Ξ as the feature value of the target gas. By doing so, the feature value capable of identifying the gas in which the plurality of types of molecules are mixed can be automatically generated from the result of sensing the gas with the sensor 10.

Using the set of the contribution values as the feature value of the target gas has advantages other than the advantage of being able to handle the gas containing the plurality of types of molecules. First, there is an advantage that the degree of similarity between gas can be easily recognized. For example, when the feature value of the target gas is represented by a vector, the degree of similarity between the gas can be easily recognized based on a distance between the feature vectors.

Further, using the set of the contribution values as the feature value has an advantage that the change in the time constant or the change in the mixing ratio can be made robust with respect to the change in the mixing ratio. The term “robustness” here is a property of “when the measurement environment or the measurement target changes slightly, the feature value to be obtained also changes slightly”.

If the feature value is robust with respect to the change in the mixing ratio, for example, for a mixed gas obtained by mixing two types of gas, the feature value is also be gradually changed when the mixing ratio of the gas is gradually changed. In Expression (4), since the contribution value ξₖ is proportional to ρₖ, which represents the concentration of the gas, this property can be seen from the fact that a slight change in concentration appears as a slight change in the contribution value.

The robustness of the change in the mixing ratio can be further increased by suppressing the amplification of the error when computing the contribution value ξₖ and stabilizing the ξₖ numerically. Therefore, as will be described later, in a method of estimating the contribution value, a scheme for suppressing the amplification of the error is introduced.

Further, if the feature value is robust with respect to the change in the time constant, when a value of the time constant (3 changes slightly, the feature value also changes slightly. The feature constants that contribute with respect to the time-series data 14 are changed according to the temperature change even when sensing is performed for the same molecule. This is because, in general, when the temperature rises, the reaction velocity of the chemical change increases, so the velocity constant βₖ is also considered to increase. On the contrary, the time constant τₖ is considered to decrease as the temperature rises. That is, if the feature value is robust with respect to the change in the time constant, it can be said to be robust against a slight temperature change. The details of the robustness of the change in the time constant will be described later.

Note that, the above description with reference to FIG. 1 is an example for facilitating understanding of the information processing apparatus 2000 and does not limit the function of the information processing apparatus 2000. Hereinafter, the information processing apparatus 2000 of the present example embodiment will be described in more detail.

<Example of Functional Configuration of Information Processing Apparatus 2000>

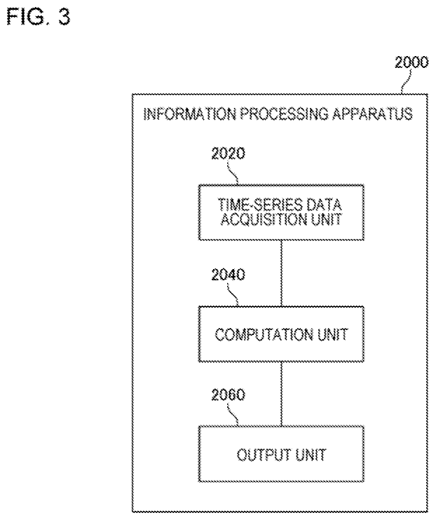

FIG. 3 is a diagram illustrating a functional configuration of the information processing apparatus 2000 according to Example Embodiment 1. The information processing apparatus 2000 includes a time-series data acquisition unit 2020,a computation unit 2040, and an output unit 2060. The time-series data acquisition unit 2020acquires the time-series data 14 from the sensor 10. The computation unit 2040 computes the contribution value that represents the magnitude of the contribution for each of the plurality of feature constants with respect to the time-series data 14. That is, the computation unit 2040 computes the contribution value ξᵢ for each feature constant θ₁. The output unit 2060 outputs the contribution value computed for each feature constant as the feature value of the gas sensed by the sensor 10. Specifically, the output unit 2060 outputs the feature vector Ξ.

<Hardware Configuration of Information Processing Apparatus 2000>

Each functional configuration unit of the information processing apparatus 2000 may be implemented by hardware (for example, a hard-wired electronic circuit or the like) that implements each functional configuration unit, or may be implemented by a combination of hardware and software (for example, a combination of an electronic circuit and a program for controlling the electronic circuit). Hereinafter, a case where each functional configuration unit of the information processing apparatus 2000 is implemented by a combination of hardware and software will be further described.

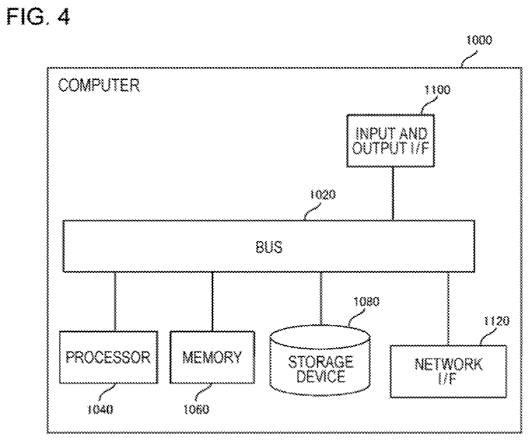

FIG. 4 is a diagram illustrating a computer 1000 for implementing the information processing apparatus 2000. The computer 1000 is any computer. For example, the computer 1000 is a stationary computer such as a personal computer (PC) or a server machine. In addition, for example, the computer 1000 is a portable computer such as a smartphone or a tablet terminal. The computer 1000 may be a dedicated computer designed to implement the information processing apparatus 2000 or may be a general-purpose computer.

The computer 1000 includes a bus 1020, a processor 1040, a memory 1060, a storage device 1080, an input and output interface 1100, and a network interface 1120. The bus 1020 is a data transmission path for the processor 1040, the memory 1060, the storage device 1080, the input and output interface 1100, and the network interface 1120 to mutually transmit and receive data. However, the method of connecting the processors 1040 and the like to each other is not limited to the bus connection.

The processor 1040 is various processors such as a Central Processing Unit (CPU), a Graphics Processing Unit (GPU), and a Field-Programmable Gate Array (FPGA). The memory 1060 is a main storage device implemented by using a Random Access Memory (RAM) or the like. The storage device 1080 is an auxiliary storage device implemented by using a hard disk, a Solid State Drive (SSD), a memory card, a Read Only Memory (ROM), or the like.

The input and output interface 1100 is an interface for connecting the computer 1000 and the input and output devices. For example, an input device such as a keyboard or an output device such as a display device is connected to the input and output interface 1100. In addition, for example, the sensor 10 is connected to the input and output interface 1100. However, the sensor 10 does not necessarily have to be directly connected to the computer 1000. For example, the sensor 10 may store the time-series data 14 in a storage device shared with the computer 1000.

The network interface 1120 is an interface for connecting the computer 1000 to a communication network. The communication network is, for example, a Local Area Network (LAN) or a Wide Area Network (WAN). A method of connecting the network interface 1120 to the communication network may be a wireless connection or a wired connection.

The storage device 1080 stores a program module that implements each functional configuration unit of the information processing apparatus 2000. The processor 1040 implements the function corresponding to each program module by reading each of these program modules into the memory 1060 and executing the modules.

<Process Flow>

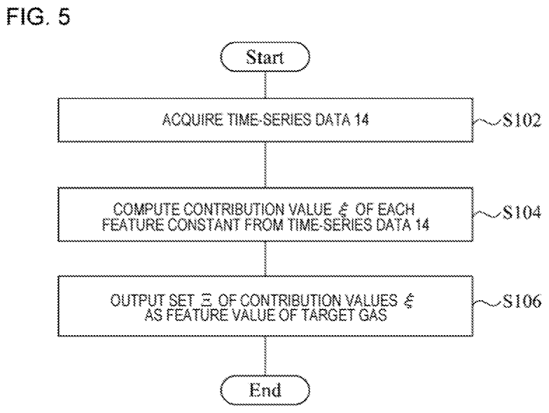

FIG. 5 is a flowchart illustrating a flow of a process executed by the information processing apparatus 2000 of Example Embodiment 1. The time-series data acquisition unit 2020 acquires the time-series data 14 (S102). The computation unit 2040 computes the contribution value ξᵢ for each feature constant (S104). The output unit 2060 outputs the feature vector Ξ (S106).

The timing at which the information processing apparatus 2000 executes the series of processes illustrated in FIG. 5 varies. For example, the information processing apparatus 2000 receives an input operation for specifying the time-series data 14 and executes the series of processes for the specified time-series data 14. In addition, for example, the information processing apparatus 2000 waits such that the time-series data 14 can be received and executes the processes after S104 according to the reception of the time-series data 14 (that is, the execution of S102).

<Acquisition of Time-Series Data 14: S102>

The time-series data acquisition unit 2020acquires the time-series data 14 (S102). A method is any method in which the time-series data acquisition unit 2020acquires the time-series data 14. For example, the information processing apparatus 2000 acquires the time-series data 14 by accessing a storage device in which the time-series data 14 is stored. The storage device in which the time-series data 14 is stored may be provided inside the sensor 10 or may be provided outside the sensor 10. In addition, for example, the time-series data acquisition unit 2020 may acquire the time-series data 14 by sequentially receiving the detected values output from the sensor 10.

The time-series data 14 is time-series data in which the detected values output by the sensor 10 are arranged in the order of earliest time output from the sensor 10. However, the time-series data 14 may be obtained by adding predetermined preprocessing with respect to the time-series data of the detected values obtained from the sensor 10. Further, instead of acquiring the preprocessed time-series data 14, the time-series data acquisition unit 2020may perform preprocessing with respect to the time-series data 14. As the preprocessing, for example, filtering for removing noise components from time-series data can be adopted.

The time-series data 14 is obtained by exposing the sensor 10 to the target gas. However, when performing a measurement related to the gas using the sensor, by repeating an operation of exposing the sensor to the gas to be measured and an operation of removing the gas to be measured from the sensor, a plurality of time-series data to be analyzed may be obtained from the sensor.

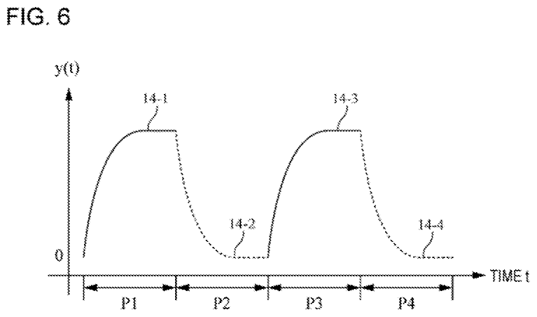

FIG. 6 is a diagram illustrating a plurality of time-series data obtained from the sensor. In FIG. 6, the rising time-series data is represented by a solid line, and the falling time-series data is represented by a dotted line so that the rising time-series data and the falling time-series data can be easily distinguished. In FIG. 6, the time-series data 14-1 of a period P1 and the time-series data 14-3 of a period P3 are obtained by the operation of exposing the sensor to the gas to be measured. The time-series data obtained by exposing the sensor to the gas to be measured in this way is called “rising” time-series data. The “when rising” in Expression (4) means “in a case where the time-series data 14 is rising time-series data”. The same applies to the following expressions.

On the other hand, the time-series data 14-2 of a period P2 and the time-series data 14-4 of a period P4 are obtained by the operation of removing the gas to be measured from the sensor. Note that, the operation of removing the gas to be measured from the sensor is implemented, for example, by exposing the sensor to gas called purge gas. The time-series data obtained by the operation of removing the gas to be measured from the sensor is called “falling” time-series data. The “when falling” in Expression (4) means “in a case where the time-series data 14 is falling time-series data”. The same applies to the following expressions.

In the information processing apparatus 2000, the time-series data 14 obtained by each of the operations of exposing the sensor 10 to the target gas and the operation of removing the target gas from the sensor 10 are distinguished and are treated as different time-series data 14. For example, in the example in FIG. 6, the time-series data obtained in each of the four periods P1 to P4 are treated as different time-series data 14. Therefore, when a series of time-series data is obtained by repeating the operation of exposing the sensor 10 to the target gas and the operation of removing the target gas from the sensor 10, it is necessary to divide the series of time-series data into a plurality of time-series data 14.

Various methods can be adopted as a method for obtaining the plurality of time-series data 14 by dividing the series of time-series data obtained from the sensor 10. For example, the plurality of time-series data 14 can be obtained by manually dividing the series of time-series data obtained from the sensor 10. In addition, for example, the information processing apparatus 2000 may acquire the series of time-series data and obtain the plurality of time-series data 14 by dividing the time-series data.

Note that, various methods can be adopted as the method of dividing the time-series data by the information processing apparatus 2000. For example, there are the following methods.

<<(a) Method Using First Derivative>>

In the time-series data 14, the derivative of a sensor value becomes discontinuous at a portion to be divided, and the absolute value becomes maximum immediately after that. Therefore, the time-series data 14 can be divided by using a point where the absolute value of the first derivative becomes large.

<<(b) Method Using Second Derivative>>

Similarly, the derivative is discontinuous at the point to be divided, so the second derivative diverges to infinity. Therefore, the time-series data 14 can be divided by using a point where the absolute value of the second derivative becomes large.

<<(c) Method of Using Metadata Obtained from Sensor>>

Depending on the type of sensor, metadata other than the detected value is provided. For example, in the MSS module, different pumps (sample pump and purge pump) are prepared for suction of the gas (sample) to be measured and the purge gas and by turning these pumps on and off alternately, the measurement of rising and the measurement of falling are performed. Further, an operation sequence of the pump (information representing which pump is used for the detected value, the flow rate measurement value used for the feedback control of the flow rate, or the like) is added to the recorded detected value as time-series information. Therefore, for example, the information processing apparatus 2000 can divide the time-series data 14 by using the operation sequence of the pump obtained together with the time-series data 14.

<<Combination of the Above Methods>>

Regarding the method (c), it is preferable to make a correction in consideration of the delay from the operation of the pump to the arrival of the gas at the sensor. Therefore, for example, the information processing apparatus 2000 tentatively divides the time-series data 14 into a plurality of sections by using the method (c) and then determines a time point at which the absolute value of the first derivative becomes maximum in each section, and divides the time-series data 14 at each determined time point.

Note that, the information processing apparatus 2000 may be configured to use only one of the time-series data 14 obtained by the operation of exposing the sensor 10 to the target gas and the time-series data 14 obtained by the operation of removing the target gas from the sensor 10.

<Regarding the Set Ξ of Feature Constants>

As described above, the set of the feature constants may be generated by the information processing apparatus 2000 or may be stored in advance in the storage device accessible from the information processing apparatus 2000. A case where the information processing apparatus 2000 generates a set of feature constants will be described in Example Embodiment 2.

The set of the feature constants can be determined by three parameters, for example, 1) the minimum value of the feature constants θₘᵢₙ, 2) the maximum value of the feature constants θₘₐₓ, and 3) the interval ds of the feature constants adjacent to each other. In this case, the set Ξ of the feature constants is expressed as Ξ={θₘᵢₙ, θₘᵢₙ+ds, θₘᵢₙ+2ds, θₘₐₓ}. Note that, in this case, make sure that (θₘₐₓ−θₘᵢₙ) is an integral multiple of ds.

The number of the feature constants ns may be determined instead of determining the interval ds of the feature constants adjacent to each other. In this case, the set Ξ of the feature constants can be determined as described above after the interval ds of the feature constants adjacent to each other is computed. Specifically, it is expressed as ds=(θₘₐₓ−θₘᵢₙ)/ns.

The feature constants may be determined by using a log scale. In this case, for example, the set of the feature constants is determined by 1) the minimum value of the feature constants θₘᵢₙ, 2) the common ratio r, and 3) the number of feature constants ns. The set Ξ of the feature constants is expressed as Ξ={θₘᵢₙ, θₘᵢₙ*r, θₘᵢₙ*r\hat{ }2, . . . , θₘᵢₙ\hat{ }(ns−1)}.

When the velocity constant β is used as the feature constant, the minimum value θₘᵢₙ of the feature constant, the maximum value θₘₐₓ of the feature constant, and the interval ds of the feature constants adjacent to each other are the minimum value βₘᵢₙ of the velocity constant, the maximum value βₘₐₓ of the velocity constant, and the interval Δβ of the velocity constants adjacent to each other, respectively. Similarly, when the time constant τ is used as the feature constant, the minimum value θₘᵢₙ of the feature constant, the maximum value θₘₐₓ of the feature constant, and the interval ds of the feature constants adjacent to each other are the minimum value τmin of the time constant, the maximum value τmax of the time constant, and the interval Δτ of the time constants adjacent to each other, respectively.

The computation unit 2040 determines the set of the feature constants by using the parameters that determine the set of the feature constants described above. These parameters are stored in, for example, the storage device accessible from the computation unit 2040. However, information listing all the feature constants may be stored in the storage device instead of storing the parameters.

<Computation of Contribution Value: S104>

The computation unit 2040 computes the contribution value ξᵢ of each feature constant θᵢ included in the set of the feature constants determined as described above (S104). For this reason, the computation unit 2040 generates a prediction model for predicting the detected value of the sensor 10 with all the contribution values ξᵢ (that is, the feature vector Ξ) as parameters. When generating the prediction model, the feature vector Ξ can be computed by performing a parameter estimation for the feature vector Ξ by using the time-series data 14 which is the observation data. An example of the prediction model when the velocity constant β is used as the feature constant can be represented by Expression (6). Further, an example of the prediction model when the time constant τ is used as the feature constant can be represented by Expression (7).

Various methods can be used for estimating the parameters of the prediction model. Hereinafter, some examples of the method will be given. Note that, in the following description, a case where the velocity constant β is used as the feature constant is described. The method of parameter estimation when the time constant τ is used as the feature constant can be implemented by reading the velocity constant β in the following description as 1/τ.

<<Parameter Estimation Method 1>>

For example, the computation unit 2040 estimates the parameter Ξ by a maximum likelihood estimation using the predicted value obtained from the prediction model and the observed value (that is, time-series data 14) obtained from the sensor 10. For the maximum likelihood estimation, for example, the least squares method can be used. In this case, specifically, the parameter Ξ is determined according to the following objective function.

$${arg min}_{Ξ ∈ {ℝ}^{m}} {\sum }_{i = 0}^{T - 1} {\vert y ( {t}_{i} ) - \hat{y} ( {t}_{i} ) \vert}^{2} \qquad ( 8 )$$

T represents the length (the number of detected values) of the time-series data 14. Further, y\hat{ }(tᵢ) represents the predicted value at time tᵢ.

The vector Ξ that minimizes the above objective function can be computed using the following Expression (9).

$$Ξ = {( {Φ}^{T} Φ )}^{- 1} Φ Y \\ {Φ}_{k , i} = \{ \begin{matrix}1 - {e}^{- {β}_{k} {t}_{i}} & when rising \\ {e}^{- {β}_{k} {t}_{i}} & when falling\end{matrix} \qquad ( 9 )$$

The vector Y is expressed as Y=(y(t₀), y(t₁), . . . ).

Therefore, the computation unit 2040 computes the parameter Ξ by applying the time-series data Y and the set of the feature constants Θ={β₁, β₂, . . . } to the above Expression (9).

<<Parameter Estimation Method 2>>

For the least squares method described above, a regularization term may be introduced to perform regularization. For example, the following Expression (10) shows an example of performing L2 regularization.

$${argmin}_{Ξ ∈ {ℝ}^{m}} {\sum }_{i = 0}^{T - 1} {\vert y ( {t}_{i} ) - \hat{y} ( {t}_{i} ) \vert}^{2} + λ {\sum }_{k} {ξ}_{k}^{2} \qquad ( 10 )$$

λ is a hyperparameter representing the weight given to the regularization term.

In this case, the parameter Ξ can be determined according to the following expression (11).

Ξ=(Φ^{T}Φ+λI)⁻¹ΦI (11)

By introducing such a regularization term, it is possible to suppress the amplification of the measurement error in the matrix computation as compared with the case where the regularization term is not introduced, thereby each contribution value ξᵢ can be computed more accurately. Further, by suppressing the amplification of the error, the contribution value ξ is numerically stable, so that the robustness of the feature value with respect to the mixing ratio is improved.

Note that, as described above, λ is the hyperparameter and needs to be determined in advance. For example, the value of λ is determined through a test measurement or a simulation. It is preferable to set the value of λ to a small value so that the contribution value ξ does not oscillate.

The simulation for determining the value of λ will be described. In the simulation, in a case where “a single molecule with a contribution of 1” is virtually measured (for example, in the case of falling, when the velocity constant of the single molecule is defined as β₀, it is expressed as y(t)=exp {−β₀*T}) is considered, and the result of the feature value estimation value by Expression (12) in this case is observed. Virtually, when it is assumed that the ideal observation (measurement can be performed for an infinitely long time at an infinitesimal measurement interval and the observation error is zero) is possible, in the simulation of a virtual single molecule, the feature value in which only β₀ has a sharp peak as shown below, is obtained, thereby the original velocity constant β=β₀ and the contribution ξ=1 are completely reproduced.

$${ξ}_{k} = \{ \begin{matrix}1 , & {β}_{k} = {β}_{0} \\ 0 , & otherwise .\end{matrix} \qquad ( 12 )$$

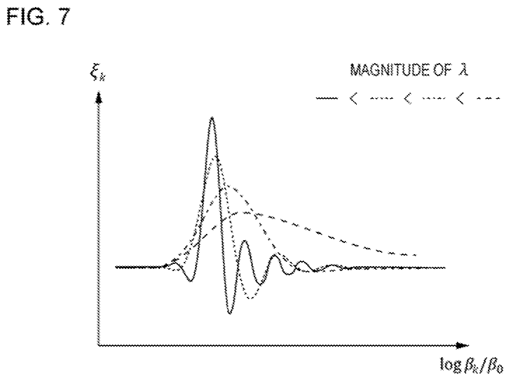

However, since the ideal observation is not possible in reality, the peak of the contribution value becomes blunted or the contribution value oscillates. FIG. 7 is a diagram illustrating the feature value obtained for a single molecule. From this diagram, the trade-off between the peak blunting and the increase of the oscillation can be seen depending on the value of λ. Specifically, when λ is too large, the oscillation decreases, but the peak width increases. When the peak width becomes large, the result of measuring two molecules having similar velocity constants looks like one large peak, and it becomes difficult to distinguish these molecules. That is, the sensitivity is reduced. On the other hand, when λ is too small, the peak width decreases, but the oscillation increases. As the oscillation increases, the robustness of the feature value lowers, as will be described later. Therefore, it can be said that it is preferable to sharpen the peak (improve the sensitivity) by determining to reduce λ to the extent that the oscillation does not occur (robustness is not impaired).

The purpose of the simulation is to evaluate the degree of occurrence of such peak blunting or the oscillation while changing λ. In order to quantitatively measure the “oscillation magnitude” and “peak width”, for example, the feature values Ξ₁ and Ξ₂ of two virtual single molecules having two different velocity constants β₁ and β₂, respectively, are computed by simulation. Thereafter, the inner product of these two feature values is computed as follows.

$$f ( Δ v ) = 〈 {Ξ}_{1} , {Ξ}_{2} 〉 = {\sum }_{k = 1}^{K} {( {Ξ}_{1} )}_{k} {( {Ξ}_{2} )}_{k} \\ wherein Δ v = log \frac{{β}_{1}}{{β}_{2}} \qquad ( 13 )$$

The function f(Δv) attenuates while oscillating. Therefore, it can be quantified with the width of the main lobe of the oscillation as the “peak width” and with the level of the side lobes as the “oscillation magnitude”. λ is determined by selecting a value of λ such that the main lobe width is as narrow as possible and the side lobe level is as small as possible.

One of the advantages of suppressing the oscillation of the feature value is that, as described above, the feature value becomes robust against changes in the time constant and the velocity constant. In other words, the feature value becomes robust with respect to the change in the temperature. The reason will be described below.

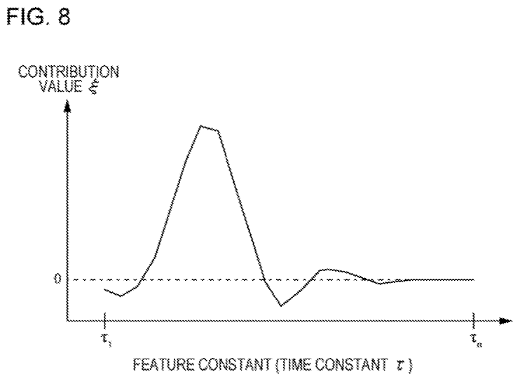

When the changes in time constant or the velocity constant occur due to the change in the temperature, the feature value illustrated in FIG. 7 or FIG. 8 described later move in parallel in the X-axis direction. When the feature value oscillates greatly, even when the feature value moves slightly in parallel in the X-axis direction, a distance between the feature vectors before and after the parallel movement becomes long. That is, even when the time constant or the velocity constant changes slightly, the feature value changes greatly, and the robustness of the feature value with respect to the change in the time constant or the change in the velocity constant becomes low.

In contrast to this, when the oscillation of the feature value is small, the distance between the feature vectors before and after the parallel movement becomes short. This means that when the time constant or velocity constant changes slightly, the feature value also changes slightly. That is, it means that the feature value is highly robust. Therefore, it can be said that the robustness of the feature value is improved by suppressing the oscillation of the feature value.

Note that, the regularization in the least squares method is not limited to the L2 regularization described above, and other regularizations such as the L1 regularization may be introduced.

<<Parameter Estimation Method 3>>

In this method, the prior distribution P(Ξ) is set for the parameter Ξ. Thereafter, the computation unit 2040 determines the parameter Ξ by using a Maximum a Posteriori (MAP) estimation that uses the time-series data 14 which is the observed value. Specifically, the parameter Ξ that maximizes the following objective function is adopted.

$${argmin}_{Ξ} P ( Y \vert Ξ ) P ( Ξ ) \qquad ( 14 )$$

P(Y|Ξ) and P(Ξ) are defined by a multivariate normal distribution, for example, as follows.

P(Y|Ξ)=N(Y|Ŷ, σ²I

P(Ξ)=N(Ξ|0, Λ) (15)

N(•|μ, Σ) is a multivariate normal distribution with average μ and covariance Σ. Further, the vector y\hat{ } is expressed as y\hat{ }=(y\hat{ }(t₁), y\hat{ }(t₂), . . . ) =ΦΞ. σ\hat{ }2 is a parameter that represents the variance of the observation error.

Λ is a covariance matrix of the prior distribution of Ξ, and any semi-normal definite matrix may be given in advance or may be determined by a method described later or the like.

Further, P(Y|Ξ) and P(Ξ) may be determined by a Gaussian process (GP) as follows.

P(ξ(β))=GP(ξ(β)|0, Λ(β, β′))

P(γ(t))=N(γ(t)|\hat{γ}(t), σ²) (16)

GP (ξ(β)|μ(β), Λ(β, β′)) is a Gaussian process having an average value function of μ(β) and a covariance function (kernel function) of Λ(β, β′). Further, since the Gaussian process is a stochastic process that generates a continuous function, here, ξ(β) is a continuous function that represents the contribution ratio with respect to β (or τ), and the vector Ξ is a vector Ξ=(ξ(β₁), ξ(β₂), . . . ) in which the values of the function ξ(β) with “β=β₁, β₂, . . . ” are arranged. In this case, Expression (15) can be regarded as a special case of Expression (16), and the (i, j) component of the covariance matrix Λ in Expression (15) is a value of the covariance function Λ (β, β′) with (β, β′)=(β₁, β₂) in Expression (16). That is, the matrix Λ in Expression. (15) is a Gram matrix in the so-called Gaussian process.

Further, the computation unit 2040 may determine the parameter E by using a Bayesian estimation that uses the time-series data 14 which is the observed value. Specifically, the parameter Ξ is determined by computing the following conditional expected value.

$$Ξ = 𝔼 [ Ξ \vert Y ] = \frac{\int Ξ P ( Y \vert Ξ ) P ( Ξ ) d Ξ}{\int P ( Y \vert Ξ ) P ( Ξ ) d Ξ} \qquad ( 17 )$$

E[Ξ|Y] is a conditional expected value assuming that Ξ and Y follow the probability distribution in Expression (16).

The feature vector Ξ that maximizes the above objective function (14) and the feature vector Ξ obtained by the above conditional expected value (17) can both be computed by the following Expression (18).

Ξ=ΛΦ^{T}(ΦΛΦ^{T}+σ²I)⁻¹Y (18)

<<<How to Determine Hyperparameters>>>

When using the Gaussian process, as the hyperparameters that are set in advance, there are a) the form of the covariance function Λ(β, β′), b) the parameters of the covariance function, and c) the measurement error parameter σ\hat{ }2. The following steps are performed while changing these parameters.

1. Simulate a measurement value of a single molecule with a virtual velocity constant β₀.

2. Estimate a feature value from the simulated measurement value.

3. Quantify the magnitude of the oscillation and the peak width of the estimated feature value.

4. Repeat steps 1 to 3 while changing the hyperparameters a to c above.

5. Determine the hyperparameters a to c such that the oscillation is small and the peak width is narrow by the grid search or the steepest descent method.

Note that, for example, the in-lobe width and side-lobe level of the above-mentioned function f(Δv) are used as indexes for quantifying the magnitude of the oscillation and peak width of the feature value. Further, besides that, the variance value (the square variance or absolute value variance) when the estimated Ξ is regarded as a probability distribution may be used. These variance values become smaller values as the oscillation is smaller and the peak width is narrower. Note that, the actual measurement (test measurement) may be carried out instead of the simulation.

<Output of Feature Value: S106>

The output unit 2060 outputs information representing the feature vector Ξ obtained by the above method (hereinafter, output information) as a feature value representing the feature of the gas (S106). For example, the output information is text data representing the feature vector Ξ. In addition, for example, the output information may be information in which the feature vector Ξ is graphically represented with a table, a graph, or the like.

FIG. 8 is a graph illustrating the feature vector Ξ. In the graph of FIG. 8, the horizontal axis indicates the time constant τ, and the vertical axis indicates the contribution value ξᵢ of the time constant τᵢ. By representing the feature vector Ξ with the graphical information in this way, it becomes easier for a person to intuitively understand the feature of the gas.

There are various specific methods for outputting the output information. For example, the output unit 2060 stores the output information in any storage device. In addition, for example, the output unit 2060 causes the display device to display the output information. In addition, for example, the output unit 2060 may transmit the output information to an apparatus other than the information processing apparatus 2000.

<Case of Computing a Plurality of Sets Ξ of Contribution Values>

The information processing apparatus 2000 may compute a set Ξ of contribution values for each of the plurality of time-series data 14 obtained for the same target gas. In this case, the output unit 2060 may use a group of the plurality of sets as the feature value of the target gas.

For example, the information processing apparatus 2000 computes a feature vector Ξᵤ and a feature vector Ξ_{d} for the rising time-series data 14 and the falling time-series data 14, respectively, and outputs {Ξᵤ, Ξ_{d}} which is the group of these sets as the feature value of the target gas.

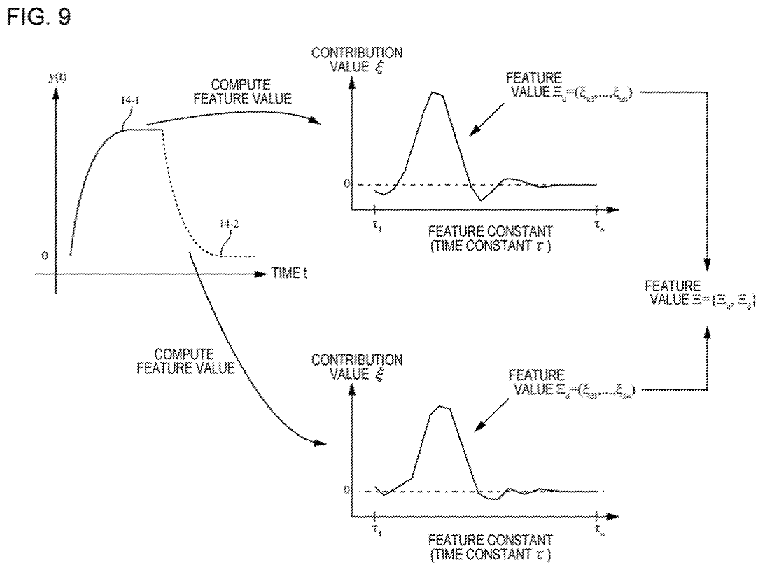

FIG. 9 is a diagram illustrating a case where the feature vector is obtained from each of the rising time-series data 14 and the falling time-series data 14. In FIG. 9, the feature vector Ξᵤ is obtained from the time-series data 14-1 which is the rising time-series data. Further, the feature vector Ξ_{d} is obtained from the time-series data 14-2 which is the falling time-series data. The output unit 2060 outputs {Ξᵤ, Ξ_{d}}, which is a combination of the two obtained feature vectors, as the feature value of the target gas.

Note that, the output unit 2060 may use one vector obtained by connecting the feature vector Ξᵤ obtained from the rising time-series data 14 and the feature vector Ξ_{d} obtained from the falling time-series data 14 as the feature value of the target gas. For example, in this case, the output unit 2060 outputs Ξ_{c}=(ξᵤ₁, ξᵤ₂, . . . , ξᵤₙ, ξ_{d1}, ξ_{d2}, . . . , ξ_{dn}) where Ξᵤ=(ξᵤ₁, ξᵤ₂, . . . , ξᵤₙ) and Ξ_{d}=(ξ_{d1}, ξ_{d2}, . . . , ξ_{dn}) are connected, as the feature value of the target gas.

Further, the output unit 2060 may output the average of the feature value obtained from the rising time-series data 14 and the feature value obtained from the falling time-series data 14 as the feature value of the target gas. That is, Ξ_{avg}=((ξᵤ₁+ξ_{d1})/2, (ξᵤ₂+ξ_{d2})/2, . . . , (ξᵤₙ+ξ_{dn})/2) is defined as the feature value of the target gas. In Expression (4), since the definition of ξ is common between the rising and the falling, ideally, the same feature value is obtained from the rising time-series data 14 and the falling time-series data 14, thereby a difference between Ξᵤ and Ξ_{d} is considered to be due to the measurement error. Therefore, by computing the average of Ξᵤ and Ξ_{d}, the influence of measurement error can be reduced.

Note that, when the concentration of the target gas increases, a difference may appear between the feature value obtained from the rising time-series data 14 and the feature value obtained from the falling time-series data 14 even when the ideal measurement is made due to the interaction between molecules. In this case, instead of taking the average between the originally different feature value, it is preferable to output these feature values separately (that is, Ξ_{c} is output).

Therefore, for example, the output unit 2060 may determine whether to output Ξ_{c} or Ξ_{avg} according to the concentration of the target gas. Specifically, a threshold value of the concentration is set in advance, and the output unit 2060 determines whether or not the concentration of the target gas is equal to or higher than the threshold value. When the concentration of the target gas is equal to or higher than the threshold value, the output unit 2060 outputs Ξ_{c} as the feature value of the target gas. On the other hand, when the concentration of the target gas is less than the threshold value, the output unit 2060 outputs Ξ_{avg} as the feature value of the target gas. However, both Ξ_{c} and Ξ_{avg} may be output regardless of the concentration of the target gas. Note that, the concentration of the target gas may be input to the information processing apparatus 2000 as a set value, or may be acquired from the sensor for measuring the concentration of the gas.

The plurality of feature vectors are not limited to those obtained from each of the rising time-series data 14 and the falling time-series data 14. For example, the plurality of time-series data 14 may be obtained by exposing each of the plurality of sensors 10 having different characteristics to the target gas. When the molecules are attached to the sensor, the ease of attachment of each molecule with respect to the sensor differs depends on the characteristics of the sensor. For example, when using a type of sensor in which molecules are attached to the functional membrane, the ease of attachment of each molecule with respect to the functional membrane differs depending on the material of the functional membrane. The same applies to the ease of detachment of each molecule. Therefore, by preparing sensors 10, which have functional membranes made of different materials, and obtaining and analyzing the time-series data 14 from each of the plurality of sensors 10, the features of the target gas can be recognized more accurately.

The information processing apparatus 2000 acquires the time-series data 14 from each of the plurality of sensors 10 having different characteristics and computes the feature vector Ξ for each time-series data 14. The output unit 2060 outputs the group of the plurality of feature vectors Ξ obtained in this way as the feature value of the target gas.

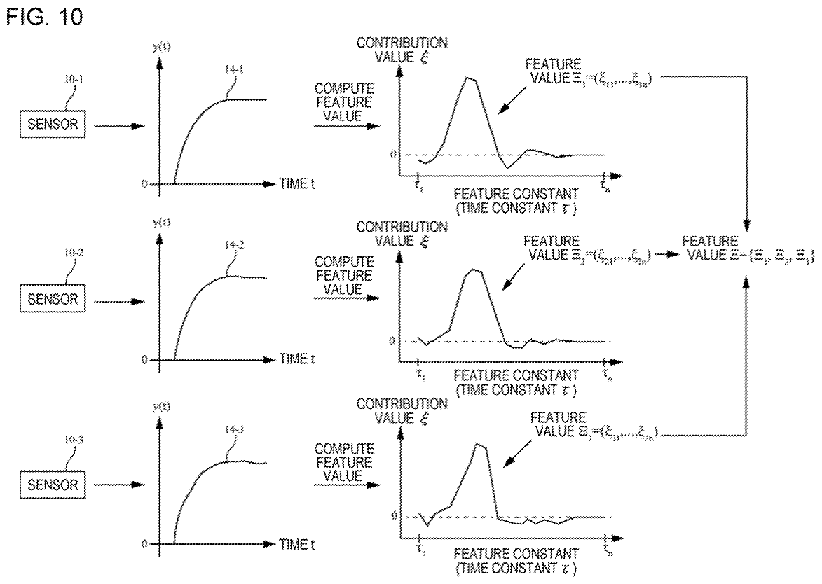

FIG. 10 is a diagram illustrating a case where the plurality of feature vectors are obtained by obtaining the time-series data 14 from each of the plurality of sensors 10. In this example, three sensors 10-1, 10-2, and 10-3, each having different characteristics, are prepared, and time-series data 14-1, 14-2, and 14-3 are obtained from each of the three sensors. The information processing apparatus 2000 computes the feature vectors Ξ₁, Ξ₂, and Ξ₃ from each of the plurality of time-series data 14. Thereafter, the information processing apparatus 2000 outputs the group of these three feature vectors as the feature value of the target gas. Note that, as described above, instead of outputting the group of the plurality of feature vectors, one feature vector Ξ_{c} in which the plurality of feature vectors are concatenated may be output.

The plurality of sensors 10 having different characteristics may be accommodated in one housing or may be accommodated in different housings. In the former case, for example, the sensor 10 is configured such that a plurality of functional membranes made of different materials are accommodated in one sensor housing and a detected value can be obtained for each functional membrane.

Further, the method described in FIG. 9 and the method described in FIG. 10 may be combined. That is, the information processing apparatus 2000 may obtain the rising time-series data 14 and the falling time-series data 14 from each of the plurality of sensors 10, compute the feature vector Ξ for each of the obtained time-series data 14, and use the group of the plurality of computed feature vectors or one feature vector in which the plurality of computed feature vectors are connected, as the feature value of the target gas.

<Computation of Feature Value Considering Bias>

The detected value of the sensor 10 may include a bias term where the time-series change does not occur. In this case, the time-series data 14 is represented as follows. Note that, the velocity constant β is used as the feature constant.

$$y ( t ) = \{ \begin{matrix}b - {\sum }_{k = 1}^{K} {ξ}_{k} {e}^{- {β}_{k} t} & when rising \\ b + {\sum }_{k = 1}^{K} {ξ}_{k} {e}^{- {β}_{k} t} & when falling\end{matrix} \qquad ( 19 )$$

wherein, b is a bias term defined as follows

$$b = \{ \begin{matrix}{b}_{0} - {ξ}_{k} & when rising \\ {b}_{0} & when falling\end{matrix}$$

The Bias is generated, for example, due to the shifting of the offset of the sensor 10. In addition, for example, the bias is generated due to the contribution of components commonly contained in the target gas and the purge gas (for example, the contribution of nitrogen or oxygen in the atmosphere).

The information processing apparatus 2000 may have a function of removing an offset from the time-series data 14. By doing so, the feature value of the target gas can be computed more accurately. Hereinafter, a method of computing the feature value in consideration of the offset will be described.

The computation unit 2040 computes the feature vector Ξ in consideration of the bias by generating the prediction model of the time-series data 14 represented by the above Expression (19). That is, the computation unit 2040 estimates the parameters Ξ and b for the prediction model represented by the Expression (19). Specifically, the computation unit 2040 estimates and b by optimizing the objective functions (8), (10), or (14) not only for Ξ but also for b. Note that, when the time constant is used as the feature constant, βₖ is replaced with 1/τₖ in Expression (19).

For example, it is assumed that Expression (14) is used as the objective function. In this case, the computation unit 2040 computes Ξ and b by the following optimization problem. The same applies when (8) or (10) is used as the objective function.

$${argmin}_{Ξ , b} P ( Y \vert Ξ , b ) P ( Ξ , b ) \qquad ( 20 )$$

The solutions Ξ and b of the above optimization problem can be computed by the following expressions.

$$b = \frac{{1}^{T} {( {ΦΛΦ}^{T} + {σ}^{2} I )}^{- 1} Y}{{1}^{T} {( {ΦΛΦ}^{T} + {σ}^{2} I )}^{- 1} 1} \\ Ξ = {{ΛΦ}^{T} ( {ΦΛΦ}^{t} + {σ}^{2} I )}^{- 1} ( Y - 1 b ) \qquad ( 21 )$$

wherein, vector 1 is, a vector in which all components are 1

By estimating both the bias b and the feature vector Ξ in this way, the effect of the bias is removed from the feature vector, and the feature vector can be computed accurately even when the bias is included in the detected value of the sensor 10.

Note that, the output unit 2060 may output the bias b or b0 in addition to the feature vector Ξ. When the bias is generated due to the shifting of the offset of the sensor, the value of b0 can be used to calibrate the sensor offset.

### Example Embodiment 2

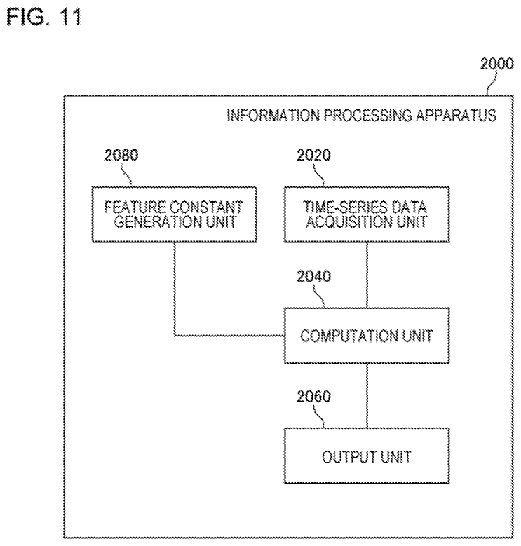

FIG. 11 is a block diagram illustrating the functional configuration of the information processing apparatus 2000 of Example Embodiment 2. The information processing apparatus 2000 according to Example Embodiment 2 has the same functions as the information processing apparatus 2000 according to Example Embodiment 1 except the points described below.

The information processing apparatus 2000 of Example Embodiment 2 further includes a feature constant generation unit 2080. The feature constant generation unit 2080 generates a set of feature constants Θ={θ₁, . . . , θₘ}. As will be described later, for example, the set of the feature constants is determined based on various parameters related to the measurement using the sensor 10, such as the sampling interval of the sensor 10. The computation unit 2040 of Example Embodiment 2 computes a set Ξ of contribution values corresponding to the set Θ of the feature constants generated by the feature constant generation unit 2080.

Note that, as will be described later, it is not necessary to use the time-series data 14 for computing the set of the feature constants. In this case, the set of the feature constants may be computed in advance before obtaining the time-series data 14 from the sensor 10.

<Advantageous Effect>

In the present example embodiment, the set Θ of the feature constants is computed by the information processing apparatus 2000. As will be described later, for example, the set of the feature constants is determined based on various parameters related to the measurement using the sensor 10, such as the sampling interval of the sensor 10. By doing so, for each measurement using the sensor 10, a set of feature constants suitable for analysis of the measurement result can be determined. Further, since the contribution values constituting the feature value of the target gas correspond to the feature constants, the feature value that accurately represents the feature of the target gas can be obtained by appropriately determining the set of the feature constants.

<Example of Hardware Configuration>

The hardware configuration of the computer that implements the information processing apparatus 2000 of Example Embodiment 2 is represented by, for example, FIG. 4 as in Example Embodiment 1. However, in the storage device 1080 of the computer 1000 that implements the information processing apparatus 2000 of the present example embodiment, a program module that implements the functions of the information processing apparatus 2000 of the present example embodiment is further stored.

<Process Flow>

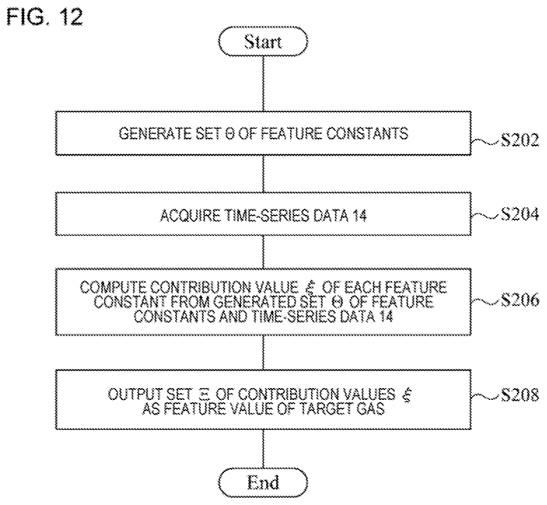

FIG. 12 is a flowchart illustrating a flow of a process executed by the information processing apparatus 2000 of Example Embodiment 2. The feature constant generation unit 2080 generates a set Θ of feature constants (S202). The time-series data acquisition unit 2020 acquires the time-series data 14 (S204). The computation unit 2040 computes the contribution value ξᵢ for each feature constant θᵢ by using the generated set Θ of the feature constants and the time-series data 14 (S206). The output unit 2060 outputs the set Ξ of the computed contribution values as the feature value of the target gas (S208).

The process flow performed by the information processing apparatus 2000 of the present example embodiment is not limited to that illustrated in FIG. 12. For example, when the time-series data 14 is used to generate a set of feature constants, the information processing apparatus 2000 executes S204 before S202.

<Generation of Set Θ of Feature Constants: S202>

The feature constant generation unit 2080 determines at least one of the parameters (the minimum value θₘᵢₙ, the maximum value θₘₐₓ, an interval ds, the number of feature constants ns, a common ratio r, or the like) that determines the feature constant described in Example Embodiment 1. Parameters other than the parameters determined by the feature constant generation unit 2080 are determined in advance.

Hereinafter, a method of determining each parameter will be described. First, a method of determining the parameter related to the time constant τ, which is an example of the feature constant, will be described.

<<How to Determine the Minimum Value of Time Constant>>

The feature constant generation unit 2080 determines the minimum value τₘᵢₙ of the time constant τ to a value that is a constant multiple of the sampling interval Δt of the sensor 10. For example, the constant C1 is set in advance. Thereafter, the feature constant generation unit 2080 determines τₘᵢₙ with τₘᵢₙ=Δt*C1.

The smaller τₘᵢₙ, the wider the feature value space (that is, two molecules with different small τ can be distinguished). Therefore, it is preferable that τₘᵢₙ is as small as possible in terms of representing the feature of the gas well. However, two different molecules having τ, which is too small compared to Δt, are difficult to distinguish in principle. Even when the contribution value is forcibly computed, a large error will appear. In this way, it is considered that the value of ξ with τ, which is too small compared to Δt, contains an error, so τₘᵢₙ is set to a constant multiple of Δt and the value of ξ with τ smaller than that is ignored.

Note that, the reason why it is difficult to distinguish two different molecules having τ, which is too small compared to Δt, in principle is as follows. First, it is assumed that y(t) is measured at time t=(0, 1, 2, 3) with Δt=1. Further, it is assumed that the time constants τ1=0.001 and τ2=0.01 are used as the feature constants. At this time, the estimation value Y\hat{ } of the observed value Y=(y0, y1, y2, y3) is decomposed as follows.

$$\begin{matrix}\hat{Y} = {ξ}_{1} ( {e}^{- \frac{0 Δ t}{{τ}_{1}}} , {e}^{- \frac{1 Δ t}{{τ}_{1}}} , {e}^{- \frac{2 Δ t}{{τ}_{1}}} {e}^{- \frac{3 Δ t}{{τ}_{1}}} ) + {ξ}_{2} ( {e}^{- \frac{0 Δ t}{{τ}_{2}}} , {e}^{- \frac{1 Δ t}{{τ}_{2}}} , {e}^{- \frac{2 Δ t}{{τ}_{2}}} {e}^{- \frac{3 Δ t}{{τ}_{2}}} ) \\ = {ξ}_{1} ( 1 , {e}^{- 1000} , {e}^{- 2000} , {e}^{- 3000} ) + {ξ}_{2} ( 1 , {e}^{- 100} , {e}^{- 200} , {e}^{- 300} )\end{matrix} \qquad ( 22 )$$

Here, exp (−100) or exp (−1000) is a very small value, thereby underflow occurs on the computer and the value becomes almost zero. Therefore, the two vectors with ξ₁ and ξ₂ as coefficients, respectively, are almost (1,0,0,0) and are parallel to each other. Therefore, for example, even when the time-series data 14 obtained from the sensor 10 is measured as Y=(1.0, 0.0, 0.0, 0.0) with two significant figures, it is difficult to know whether (ξ₁, ξ₂) is defined as (1,0), (0,1), or (0.5,0.5).

In other words, when τₘᵢₙ is too small, rows in an area where T is small in the matrix Φ (β is large: around the last row) have almost all values (1, 0, 0, 0, . . . ), and the rows are almost linearly dependent. As a result, Φ\hat{ }TΦ in Expression (9) and the like becomes a (substantially) singular matrix, so the estimation value in the area contains a large error (it corresponds to forcibly obtaining ξ₁ and ξ₂ as described above). Note that, even when the regularization term is used as in Expression (10), the value in the area is constant, so it does not contain useful information (In the above example, it corresponds to the case where ξ₁ and ξ₂ are distributed so as to be as constant as possible, such as (0.5, 0.5)).

In any case, in order to obtain the contribution value ξ with high accuracy, it is necessary to prevent the above-mentioned vector (exp(−0Δt, exp(−1Δt/τ), exp(−2Δt/τ), exp(−3Δt/τ), . . . ) from degenerating to (1, 0, 0, . . . ). Specifically, it is necessary to limit the value of τ such that the second term of the above vector exp(−1Δt/τ) is larger than a certain value ε(0<ε<1). More specifically, the value of τ is limited by setting the minimum value of τ as follows.

$${e}^{- \frac{Δ t}{τ}} \geq ɛ \\ {τ}_{min} = \frac{Δ t}{log {ɛ}^{- 1}} = Δ t {C}_{1} \qquad ( 23 )$$

Note that, in order to determine the minimum value of the time constant τ by using the above method, the feature constant generation unit 2080 needs to recognize the sampling interval of the sensor 10. There are various methods for the feature constant generation unit 2080 to recognize the sampling interval of the sensor 10. For example, the feature constant generation unit 2080 recognizes the sampling interval of the sensor 10 by receiving the input of data indicating the sampling interval of the sensor 10 from a user. In addition, for example, the feature constant generation unit 2080 may recognize the sampling interval of the sensor 10 by acquiring the data indicating the sampling interval of the sensor 10 from the storage device in which the data indicating the sampling interval of the sensor 10 is stored.

<<How to Determine the Maximum Value of Time Constant>>

The feature constant generation unit 2080 determines the maximum value τₘₐₓ of the time constant τ to a value equal to or greater than the total length (hereinafter, a measurement length) T of a measurement period by the sensor 10. For example, a value C2 of one or more is set in advance. Thereafter, the feature constant generation unit 2080 determines τₘₐₓ with τₘₐₓ=T*C2.

Just as it is difficult in principle to distinguish two different molecules having too small τ, it is difficult in principle to distinguish two different molecules having too large τ. For example, assuming that τ1=1000 and τ2=10000, when Δt=1 and T=3, the predicted value Y\hat{ } of the detected value is as follows.

$$\begin{matrix}\hat{Y} = {ξ}_{1} ( {e}^{- \frac{0 Δ t}{{τ}_{1}}} , {e}^{- \frac{1 Δ t}{{τ}_{1}}} , {e}^{- \frac{2 Δ t}{{τ}_{1}}} {e}^{- \frac{3 Δ t}{{τ}_{1}}} ) + {ξ}_{2} ( {e}^{- \frac{0 Δ t}{{τ}_{2}}} , {e}^{- \frac{1 Δ t}{{τ}_{2}}} , {e}^{- \frac{2 Δ t}{{τ}_{2}}} {e}^{- \frac{3 Δ t}{{τ}_{2}}} ) \\ = {ξ}_{1} ( 1 , {e}^{- 0.001} , {e}^{- 0.002} , {e}^{- 0.003} ) + {ξ}_{2} ( 1 , {e}^{- 0.0001} , {e}^{- 0.0002} , {e}^{- 0.0003} )\end{matrix} \qquad ( 24 )$$

In this way, both of the two vectors degenerate to a value close to (1, 1, 1, 1). In this case, the last term exp(−T/τ) need to be separated by E from one so that the row vector of Φ does not degenerate to (1, 1, 1, 1). Therefore, the value of τ is limited by determining the maximum value of τ as follows.

$${e}^{- \frac{T}{τ}} \leq 1 - ɛ \\ {τ}_{max} = \frac{T}{log {( 1 - ɛ )}^{- 1}} = {TC}_{2} \qquad ( 25 )$$

Note that, in order to determine the maximum value of the time constant τ by the above method, the feature constant generation unit 2080 needs to recognize the measurement length T. There are various methods for the feature constant generation unit 2080 to recognize the measurement length. For example, the feature constant generation unit 2080 recognizes the measurement length by using the time-series data 14. Specifically, the feature constant generation unit 2080 computes the measurement length by using the number of detected values constituting the time-series data 14 and the sampling interval of the sensor 10. In addition, for example, the feature constant generation unit 2080 may recognize the measurement length by the same method as the method of recognizing the sampling interval of the sensor 10.

<<How to Determine the Interval of Time Constant>>

The interval of the time constant is determined through simulation, for example, as follows.

1. Simulate the measurement waveform y(t)=exp(−β₀t) of a virtual single molecule (velocity constant β₀).

2. Compute the feature value Ξ of the virtual measurement waveform.

3. Determine the peak width of Ξ (the main lobe width).

4. Determine the interval of the time constant to be C3, a constant multiple of the peak width (main lobe width). Note that, C3<=1.

In step 2, it is preferable to obtain the feature value Ξ at a finer interval than expected. In step 4, the interval of the time constant is smaller than the peak width determined in step 3, and the interval of the time constant is determined. Note that, the meaning of the peak width and the method of quantifying the peak width are as described in the explanation of the method of determining the weight λ of the regularization term of the least squares method.

Note that, when using the log scale, the common ratio r is determined based on the interval of the time constant determined as described above.

The interval of the time constant may be determined by a theoretical approximate computation without using a simulation. As a result, the interval can be determined with a smaller amount of computation than actually simulating Ξ at a fine interval. For example, the limit in which the above-mentioned the “finer interval than expected” is infinitesimal, is considered. This corresponds to the case of using the Gaussian process described above, and the feature value Ξ is a continuous function ξ(β) of the velocity constant (or time constant). For example, under the following assumptions, the peak width 1 of Ξ can be approximately computed by Expression (27).

(Assumption 1) The feature variable is a velocity constant, and the scale is a log scale.

(Assumption 2) The method for estimating the feature value is “estimation method 3”, which is a case where the Gaussian process is used.

(Assumption 3) The covariance matrix Λ is defined as follows.

Λ=σ_{ξ}²I (26)

This corresponds to the case where the prior distribution of each ξk is defined as a normal distribution with average 0 and variance σ\hat{ }2ξ

$$ℓ \approx erf ( \frac{1}{\sqrt{2}} ) \cdot \frac{{{ψ}^{T} ( Ψ + η I )}^{- 1} ψ}{Tr [ {( Ψ + η I )}^{- 1} Ψ ]} \qquad ( 27 )$$

wherein, the meaning of each symbol is as follows.

$$Matrix Ψ := {ΦΦ}^{T}$$

$$vector ψ := ( ψ ( {t}_{1} ) , ψ ( {t}_{2} ) , … )$$

$$function ψ ( t ) := {\int }_{{β}_{min}}^{{β}_{max}} {e}^{- β t} d ( log β ) = \{ \begin{matrix}log \frac{{β}_{max}}{{β}_{min}} & t = 0 \\ Ei ( - {β}_{max} t ) - Ei ( - {β}_{min} t ) , & t > 0\end{matrix} \\ \begin{matrix}exponential integral \\ ( special function )\end{matrix} Ei ( x ) := - {\int }_{- x}^{∞} \frac{{e}^{- t}}{t} dt \\ η := \frac{{σ}^{2}}{{σ}_{ξ}^{2}}$$

σ_{ξ}²: Hyperparameters that determine Λ
σ². Variance of observation error (σ\hat{ }2 in Expression (16))

Here, the matrix Ψ corresponds to the matrix ΦΛΦ\hat{ }T in Expression (18). Specifically, since Λ=σ\hat{ }2I, it appears as shown in the expression below.

ΦΛΦ^{T}=σ_{ξ}²ΦΦ^{T}=σ_{ξ}²Ψ (28)

Since Φ is an actual matrix, the contingent Φ* as a linear operator and the matrix transpose Φ\hat{ }T are the same. Further, using the function ψ(t), the i and j components of the matrix Ψ appear as shown in the expression below.

Ψᵢⱼ=ψ(tᵢ+tⱼ) (29)

Furthermore, the matrix (Ψ+ηI)\hat{ }(−1) in Expression (27) corresponds to (ΦΛΦ+σ\hat{ }2I)\hat{ }−1 in Expression (18). Specifically, it is expressed as follows.

(ΦΛΦ+σ²I)⁻¹=(σ_{ξ}²Ψ+σ²I)⁻¹=σ_{ξ}⁻² (Ψ+ηI)⁻¹ (30)

<<Regarding the Method of Determining the Velocity Constant β>>

The velocity constant β is the reciprocal of the time constant τ. Therefore, the method of determining the minimum value of β and the method of determining the maximum value of β are the same as the method of determining the maximum value of τ and the method of determining the minimum value of τ, respectively. Further, the interval of the velocity constant β can be determined by the same method as the time constant τ.

<Type of Set of Feature Constants to be Generated>

There are types of set of the feature constants such as 1) a set of velocity constants β with a fixed interval, 2) a set of velocity constants β with a log scale, 3) a set of time constants τ with a fixed interval, and 4) a set of velocity constants τ with a log scale. The feature constant generation unit 2080 generates a set of feature constants of any kind. The type of set of feature constants to be generated may be predetermined or may be specified by the user.

Although the example embodiments of the present invention have been described above with reference to the drawings, these are examples of the present invention, and a configuration in which the above example embodiments are combined or various configurations other than the above can be adopted.

The whole or part of the example embodiments disclosed above can be described as, but not limited to, the following supplementary notes.

1. An information processing apparatus including: an acquisition unit that acquires time-series data of detected values output from a sensor where a detected value thereof changes according to attachment and detachment of a molecule contained in a target gas; a computation unit that computes a contribution value representing a magnitude of contribution for each of a plurality of feature constants with respect to the time-series data; and an output unit that outputs the contribution value computed for each feature constant as a feature value of gas sensed by the sensor, in which the feature constant is a time constant or a velocity constant related to a magnitude of a temporal change of the number of molecules attached to the sensor.

2. The information processing apparatus according to 1, in which the computation unit computes each contribution value by performing, for a prediction model of the detected value of the sensor with the contribution value of each of the plurality of feature constants as a parameter, a parameter estimation that uses the acquired time-series data.

3. The information processing apparatus according to 2, in which the computation unit computes each of the contribution values by performing, for time-series data obtained from the prediction model and the acquired time-series data, a maximum likelihood estimation that uses a least squares method.

4. The information processing apparatus according to 3, in which in the maximum likelihood estimation in the least squares method, a regularization term is included in an objective function.

5. The information processing apparatus according to 2, in which the computation unit computes each of the contribution values by using a Maximum a Posteriori (MAP) estimation or a Bayesian estimation that uses a prior distribution of each of the contribution values and the acquired time-series data.

6. The information processing apparatus according to 5, in which the prior distribution is a multivariate normal distribution or a Gaussian process.

7. The information processing apparatus according to any one of 2. to 6, in which the prediction model contains a parameter that represents a bias, and the computation unit estimates parameters that each represent the contribution value and the bias for the prediction model.

8. The information processing apparatus according to any one of 1. to 7, in which the acquisition unit acquires a plurality of time-series data, the computation unit computes a set of contribution values for each of the plurality of time-series data, and the output unit outputs a group of a plurality of the computed sets of the contribution values or an average of the plurality of the computed sets of the contribution values as the feature value of the target gas.

9. The information processing apparatus according to 8, in which the plurality of time-series data include both time-series data obtained when the sensor is exposed to the target gas and time-series data obtained when the target gas is removed from the sensor.

10. The information processing apparatus according to 8, in which the plurality of time-series data include time-series data obtained from each of a plurality of the sensors having different characteristics.

11. The information processing apparatus according to any one of 1. to 10, further including: a feature constant generation unit that generates a plurality of the feature constants by determining any one or more of a minimum value of the feature constant, a maximum value of the feature constant, and an interval of the feature constants adjacent to each other.

12. The information processing apparatus according to 11, in which the feature constant generation unit determines, when the feature constant is the time constant, a value obtained by multiplying a measurement interval of the sensor by a predetermined constant as a minimum value of the time constant, and determines, when the feature constant is the velocity constant, a value obtained by multiplying a measurement interval of the sensor by a predetermined constant as a maximum value of the velocity constant.

13. The information processing apparatus according to 11, in which the feature constant generation unit determines, when the feature constant is the time constant, a value obtained by multiplying a length of measurement by the sensor by a predetermined constant as a maximum value of the time constant, and determines, when the feature constant is the velocity constant, a value obtained by multiplying a length of measurement by the sensor by a predetermined constant as a minimum value of the velocity constant.

14. The information processing apparatus according to 11, in which when the contribution value for gas that contains only a single type of molecule is represented as a function of the feature constant, the feature constant generation unit predicts a peak width of the function and determines a value obtained by multiplying the predicted peak width by a predetermined constant as the interval of the feature constants.

15. A control method executed by a computer, the method including: an acquisition step of acquiring time-series data of detected values output from a sensor where a detected value thereof changes according to attachment and detachment of a molecule contained in a target gas; a computation step of computing a contribution value representing a magnitude of contribution for each of a plurality of feature constants with respect to the time-series data; and an output step of outputting the contribution value computed for each feature constant as a feature value of gas sensed by the sensor, in which the feature constant is a time constant or a velocity constant related to a magnitude of a temporal change of the number of molecules attached to the sensor.

16. The control method according to 15, in which in the computation step, each contribution value is computed by performing parameter estimation, which uses the acquired time-series data, on a prediction model of the detected value of the sensor with the contribution value of each of the plurality of feature constants as a parameter.

17. The control method according to 16, in which in the computation step, each of the contribution values is computed by performing, for time-series data obtained from the prediction model and the acquired time-series data, a maximum likelihood estimation that uses a least squares method.

18. The control method according to 17, in which in the maximum likelihood estimation in the least squares method, a regularization term is included in an objective function.

19. The control method according to 16, in which in the computation step, each of the contribution values is computed by using a Maximum a Posteriori (MAP) estimation or a Bayesian estimation that uses a prior distribution of each of the contribution values and the acquired time-series data.

20. The control method according to 19, in which the prior distribution is a multivariate normal distribution or a Gaussian process.

21. The control method according to any one of 16. to 20, in which the prediction model contains a parameter that represents a bias, and in the computation step, parameters that each represent the contribution value and the bias are estimated for the prediction model.

22. The control method according to any one of 15. to 21, in which in the acquisition step, a plurality of time-series data are acquired, in the computation step, a set of contribution values is computed for each of the plurality of time-series data, and in the output step, a group of a plurality of the computed sets of the contribution values or an average of the plurality of the computed sets of the contribution values is output as the feature value of the target gas.

23. The control method according to 22, in which the plurality of time-series data include both time-series data obtained when the sensor is exposed to the target gas and time-series data obtained when the target gas is removed from the sensor.

24. The control method according to 22, in which the plurality of time-series data include time-series data obtained from each of a plurality of the sensors having different characteristics.

25. The control method according to any one of 15. to 24, further including: a feature constant generation step of generating a plurality of the feature constants by determining any one or more of a minimum value of the feature constant, a maximum value of the feature constant, and an interval of the feature constants adjacent to each other.

26. The control method according to 25, in which in the feature constant generation step, when the feature constant is the time constant, a value obtained by multiplying a measurement interval of the sensor by a predetermined constant is determined as a minimum value of the time constant, and when the feature constant is the velocity constant, a value obtained by multiplying a measurement interval of the sensor by a predetermined constant is determined as a maximum value of the velocity constant.

27. The control method according to 25, in which in the feature constant generation step, when the feature constant is the time constant, a value obtained by multiplying a length of measurement by the sensor by a predetermined constant is determined as a maximum value of the time constant, and when the feature constant is the velocity constant, a value obtained by multiplying a length of measurement by the sensor by a predetermined constant is determined as a minimum value of the velocity constant.

28. The control method according to 25, in which when the contribution value for gas that contains only a single type of molecule is represented as a function of the feature constant, in the feature constant generation step, a peak width of the function is predicted and a value obtained by multiplying the predicted peak width by a predetermined constant is determined as the interval of the feature constants.

29. A program that causes a computer to execute each step of the control method according to any one of 15. to 28.

What is claimed is:

1. An information processing apparatus comprising:
an acquisition unit that acquires time-series data of detected values output from a sensor where a detected value thereof changes according to attachment and detachment of a molecule contained in a target gas;
a computation unit that computes a contribution value representing a magnitude of contribution for each of a plurality of feature constants with respect to the time-series data; and
an output unit that outputs the contribution value computed for each feature constant as a feature value of gas sensed by the sensor, wherein
the feature constant is a time constant or a velocity constant related to a magnitude of a temporal change of the number of molecules attached to the sensor.

2. The information processing apparatus according to claim 1, wherein
the computation unit computes each contribution value by performing, for a prediction model of the detected value of the sensor with the contribution value of each of the plurality of feature constants as a parameter, a parameter estimation that uses the acquired time-series data.

3. The information processing apparatus according to claim 2, wherein
the computation unit computes each of the contribution values by performing, for time-series data obtained from the prediction model and the acquired time-series data, a maximum likelihood estimation that uses a least squares method.

4. The information processing apparatus according to claim 3, wherein
in the maximum likelihood estimation in the least squares method, a regularization term is included in an objective function.

5. The information processing apparatus according to claim 2, wherein
the computation unit computes each of the contribution values by using a Maximum a Posteriori (MAP) estimation or a Bayesian estimation that uses a prior distribution of each of the contribution values and the acquired time-series data.

6. The information processing apparatus according to claim 5, wherein
the prior distribution is a multivariate normal distribution or a Gaussian process.

7. The information processing apparatus according to claim 2, wherein
the prediction model contains a parameter that represents a bias, and
the computation unit estimates parameters that each represent the contribution value and the bias for the prediction model.

8. The information processing apparatus according to claim 1, wherein
the acquisition unit acquires a plurality of time-series data,
the computation unit computes a set of contribution values for each of the plurality of time-series data, and
the output unit outputs a group of a plurality of the computed sets of the contribution values or an average of the plurality of the computed sets of the contribution values as the feature value of the target gas.

9. The information processing apparatus according to claim 8, wherein
the plurality of time-series data include both
time-series data obtained when the sensor is exposed to the target gas and
time-series data obtained when the target gas is removed from the sensor.

10. The information processing apparatus according to claim 8, wherein
the plurality of time-series data include time-series data obtained from each of a plurality of the sensors having different characteristics.

11. The information processing apparatus according to claim 1, further comprising:
a feature constant generation unit that generates a plurality of the feature constants by determining any one or more of a minimum value of the feature constant, a maximum value of the feature constant, and an interval of the feature constants adjacent to each other.

12. The information processing apparatus according to claim 11, wherein
the feature constant generation unit
determines, when the feature constant is the time constant, a value obtained by multiplying a measurement interval of the sensor by a predetermined constant as a minimum value of the time constant, and
determines, when the feature constant is the velocity constant, a value obtained by multiplying a measurement interval of the sensor by a predetermined constant as a maximum value of the velocity constant.

13. The information processing apparatus according to claim 11, wherein
the feature constant generation unit
determines, when the feature constant is the time constant, a value obtained by multiplying a length of measurement by the sensor by a predetermined constant as a maximum value of the time constant, and
determines, when the feature constant is the velocity constant, a value obtained by multiplying a length of measurement by the sensor by a predetermined constant as a minimum value of the velocity constant.

14. The information processing apparatus according to claim 11, wherein
when the contribution value for gas that contains only a single type of molecule is represented as a function of the feature constant, the feature constant generation unit predicts a peak width of the function and determines a value obtained by multiplying the predicted peak width by a predetermined constant as the interval of the feature constants.

15. A control method executed by a computer, the method comprising:
acquiring time-series data of detected values output from a sensor where a detected value thereof changes according to attachment and detachment of a molecule contained in a target gas;
computing a contribution value representing a magnitude of contribution for each of a plurality of feature constants with respect to the time-series data; and
outputting the contribution value computed for each feature constant as a feature value of gas sensed by the sensor, wherein
the feature constant is a time constant or a velocity constant related to a magnitude of a temporal change of the number of molecules attached to the sensor.

16-28. (canceled)

29. A non-transitory storage medium storing a program that causes a computer to execute a control method, the control method comprising:
acquiring time-series data of detected values output from a sensor where a detected value thereof changes according to attachment and detachment of a molecule contained in a target gas;
computing a contribution value representing a magnitude of contribution for each of a plurality of feature constants with respect to the time-series data; and
outputting the contribution value computed for each feature constant as a feature value of gas sensed by the sensor, wherein
the feature constant is a time constant or a velocity constant related to a magnitude of a temporal change of the number of molecules attached to the sensor.
